(19) United States
(12) Patent Application Publication
(10) Pub. No.: US 2026/0081450 A1
(43) Pub. Date: Mar. 19, 2026

(54) HANDHELD FAN

(71) Applicant: Xigang DING, Liling City (CN)

(72) Inventor: Xigang DING, Liling City (CN)

(73) Assignee: Shenzhen Sketching Technology Co., Ltd., Shenzhen (CN)

(21) Appl. No.: 19/399,575

(22) Filed: Nov. 24, 2025

(30) Foreign Application Priority Data
Oct. 28, 2025 (CN) 202522282587.6

(51) Int. Cl. H02J 7/00; F04D 25/06; F04D 25/08; F21V 33/00; F21Y 115/10; H02P 23/00

(52) U.S. Cl. CPC H02J 7/90; F04D 25/0673; F04D 25/084; F21V 33/0096; H02P 23/00; F21Y 2115/10

(57) ABSTRACT

Disclosed is a handheld fan, which includes a holding part, a fan head and a control device. The holding part is provided with an accommodating space inside, and is equipped with a discharge port and a charging port. The discharge port is configured for electrical connection to an external electronic device, while the charging port is for electrical connection to an external power source. The fan head is provided with a motor and fan blades connected to the motor, and the fan head is connected to the holding part. The control device is located in the accommodating space and includes a power module, a processor, a charging circuit, and a current output circuit. With the above structure, the handheld fan has controllable charging and discharging, external power supply capability, and adjustable wind speed.

### CROSS-REFERENCE TO RELATED APPLICATIONS

The present application claims the benefit, under 35 USC § 119(e), of Chinese Patent Application No. 202522282587.6, filed on Oct. 28, 2025 in the China National Intellectual Property Administration (CNIPA). The disclosure of the aforementioned application is incorporated in the present application by reference in its entirety.

### TECHNICAL FIELD

The present application relates to the field of fans, and in particular to a handheld fan.

### BACKGROUND OF THE INVENTION

Due to its small size, light weight, and portability, the handheld fan is widely used as a cooling tool in people's daily lives.

Most existing handheld fans are limited to a sole function: air blowing. Their power modules rely on external power sources for charging, but they lack intelligent detection of the state of the power source during charging, which easily leads to overcharging and undercharging problems, thereby shortening the service life of the power modules. At the same time, when the users are outdoors, they often encounter the need to charge electronic devices such as mobile phones due to low battery. However, existing handheld fans lack the capability to offer emergency power supply, resulting in significant functional limitations. If an extra charging power source is carried along, more carrying space will be required.

In view of this, the present application provides a handheld fan that can effectively solve at least one of the above-mentioned problems.

### SUMMARY OF THE INVENTION

To overcome the problems of the related art, the present application provides a handheld fan with controllable charging and discharging, external power supply capability, and adjustable wind speed.

The solution of the present application is given below.

A handheld fan includes:
a holding part provided with an accommodating space inside and equipped with a discharge port and a charging port, the discharge port being configured for electrical connection to an external electronic device, and the charging port being configured for electrical connection to an external power source;
a fan head connected to the holding part and provided with a motor and fan blades connected to the motor; and
a control device located in the accommodating space and including:
a power module electrically connected to the motor, a processor, a charging circuit, and a current output circuit;
the processor electrically connected to the motor, the charging circuit and the current output circuit, and configured for controlling output power of the motor, generating a first control signal to the charging circuit based on a first state signal from the charging circuit, and generating a second control signal to the current output circuit based on a second state signal from the current output circuit;
the charging circuit electrically connected to the charging port and configured for detecting an input state of external current at the charging port and a state of the power module, generating the first state signal accordingly, and regulating a charging state of the power module according to the first control signal from the processor; and
the current output circuit electrically connected to the processor and the discharge port, and configured for detecting whether an external electronic device is connected to the discharge port, generating a second state signal accordingly, and regulating current to the external electronic device according to the second control signal.

The beneficial effect of the present application is that, with the above structure, a handheld fan with controllable charging and discharging, external power supply capability, and adjustable wind speed is provided.

### BRIEF DESCRIPTION OF DRAWINGS

In order to more clearly illustrate the embodiments of the present application, a brief description will be made related to the figures used in the description of embodiments. The figures in the following description are only some embodiments of the present application. It will be apparent to those skilled in the art that other figures can be obtained according to the structures shown in the figures without creative work.

The present application will be further described below with reference to the accompanying drawings and embodiments.

FIG. 1 is a principle block diagram of a control device of a handheld fan according to an embodiment of the present application.

FIG. 2 is another principle block diagram of the control device of the handheld fan according to an embodiment of the present application.

FIG. 3 is a circuit diagram of a processor of the handheld fan of the present application.

FIG. 4 is a circuit diagram of a charging circuit and a current output circuit of the handheld fan according to an embodiment of the present application.

FIG. 5 is a circuit diagram of a motor control circuit of the handheld fan according to an embodiment of the present application.

FIG. 6 is a circuit diagram of a TEC control output circuit of the handheld fan according to an embodiment of the present application.

FIG. 7 is a circuit diagram of an illumination driving circuit of the handheld fan according to an embodiment of the present application.

FIG. 8 is a circuit diagram of a display assembly of the handheld fan according to an embodiment of the present application.

FIG. 9 is a circuit diagram of a charging detection circuit of the handheld fan according to an embodiment of the present application.

FIG. 10 is a schematic isometric view of a handheld fan according to a first embodiment of the present application, viewed from one perspective.

FIG. 11 is a schematic isometric view of the handheld fan according to the first embodiment of the present application, viewed from another perspective.

FIG. 12 is a schematic isometric view of a handheld fan according to a second embodiment of the present application, viewed from one perspective.

FIG. 13 is a schematic isometric view of the handheld fan according to the second embodiment of the present application, viewed from another perspective.

FIG. 14 is an exploded view of the handheld fan according to the second embodiment of the present application, viewed from one perspective.

FIG. 15 is an exploded view of the handheld fan according to the second embodiment of the present application, viewed from another perspective.

Reference numerals are given below.

1: Holding part; 12: Discharge port; 13: Charging port; 14: First rotating shaft; 15: Second rotating shaft; 2: Fan head; 21: Motor; 22: Fan blades; 3: Control device; 31: Power module; 311: Battery; 32: Processor; 33: Motor control circuit; 331: Boost circuit; 332: Motor output control circuit; 34: TEC control circuit; 35: Illumination driving circuit; 36: Display element; 37: Charging circuit; 38: Current output circuit; 39: Charging detection circuit; 4: TEC module; 5: Illuminating element; 6: Display assembly; Q1: first switch; Q2: Second switch; Q3: Third switch; Q4: Bipolar transistor; Q5: Fourth switch; C10: First filter capacitor; C2: Second filter capacitor; C3: Fifth filter capacitor; C4: Sixth filter capacitor; C5: Fourth filter capacitor; C6: Third filter capacitor; C7: First output energy storage capacitor; C8: Second output energy storage capacitor; D1: Rectifier; R1: Fourth current-limiting resistor; R2: Fifth current-limiting resistor; R6: Third current-limiting resistor; R7: First current-limiting resistor; R10: Second current-limiting resistor; R11: Load resistor; R15: Sixth current-limiting resistor; R16: Pull-down resistor; L1: Second inductor; L2: First inductor; OUT1: Motor output terminal; JMP1: First jumper.

### DETAILED DESCRIPTION OF THE INVENTION

### First Embodiment

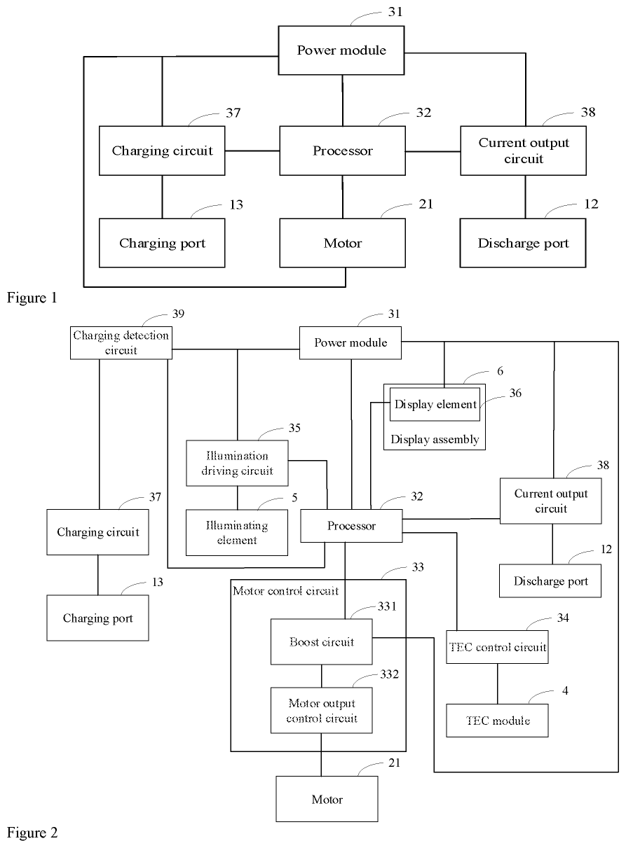

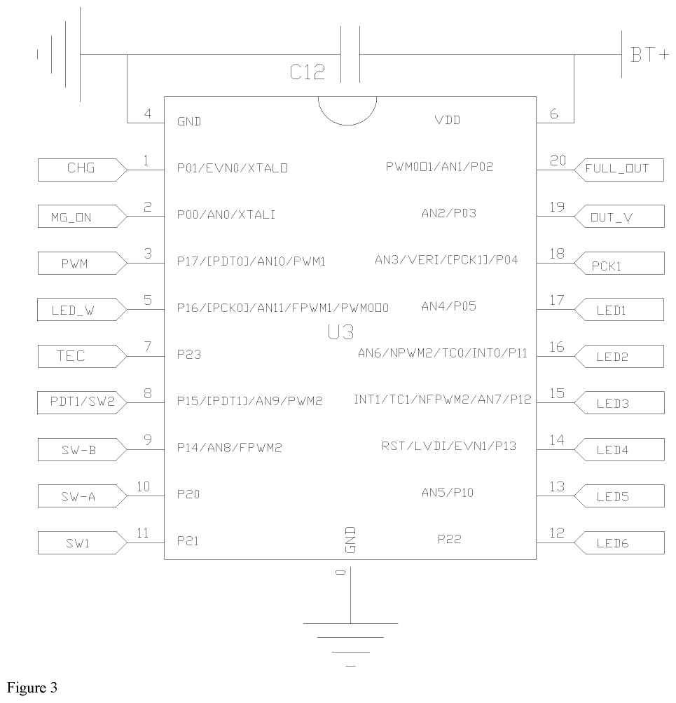

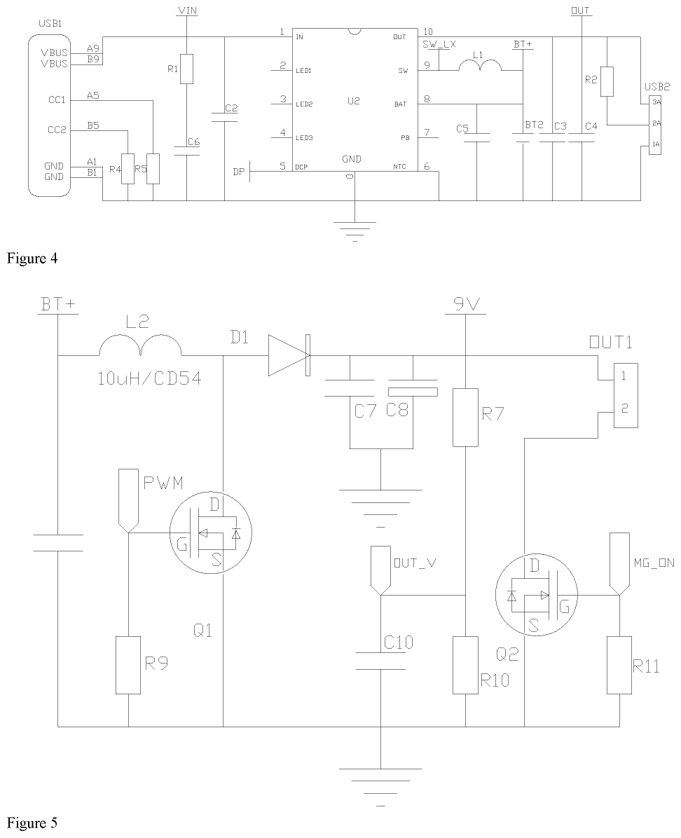

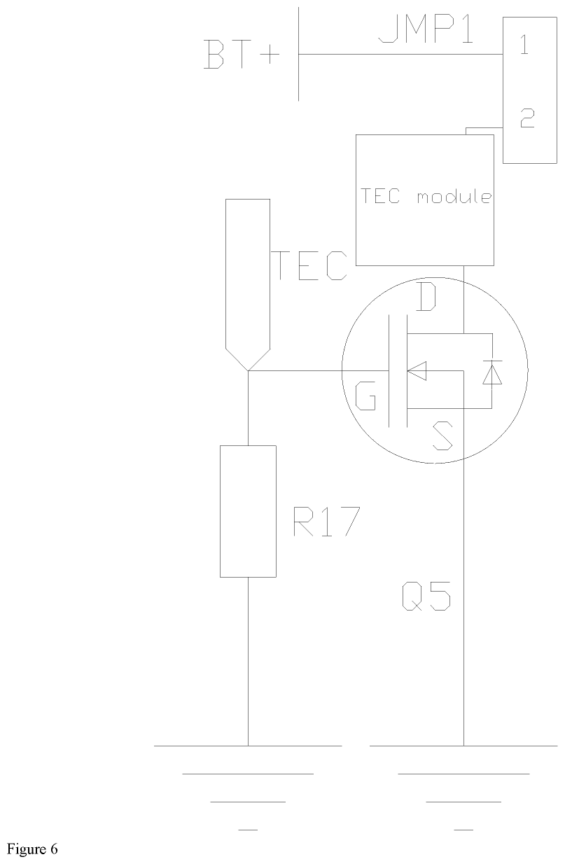

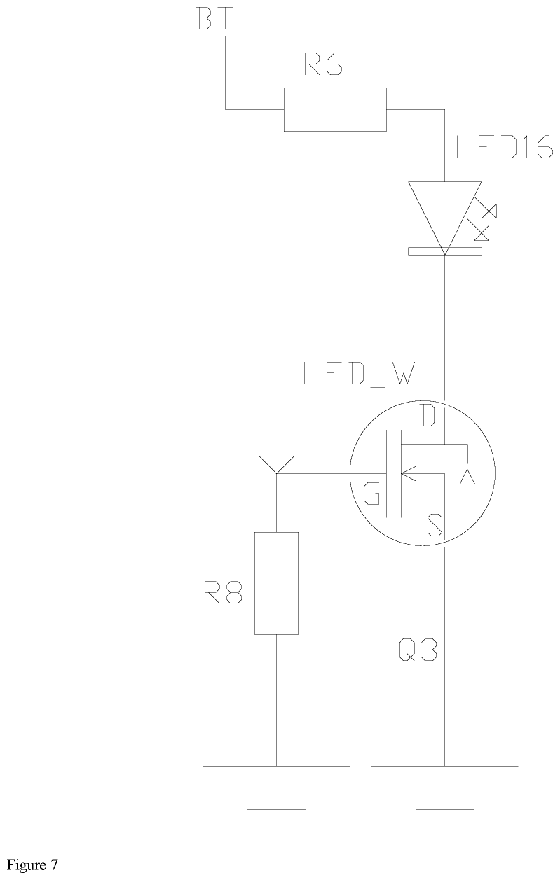

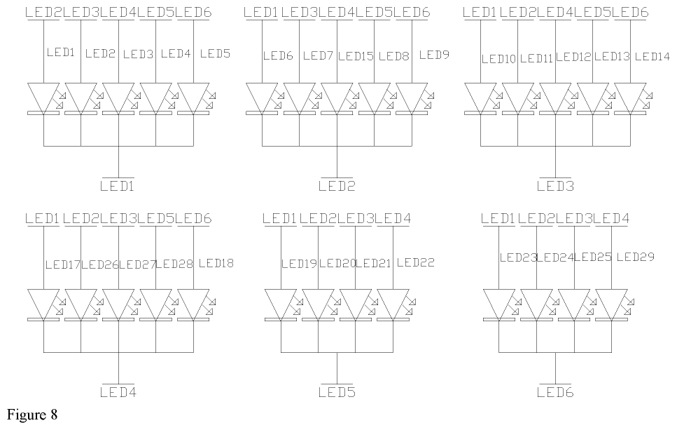

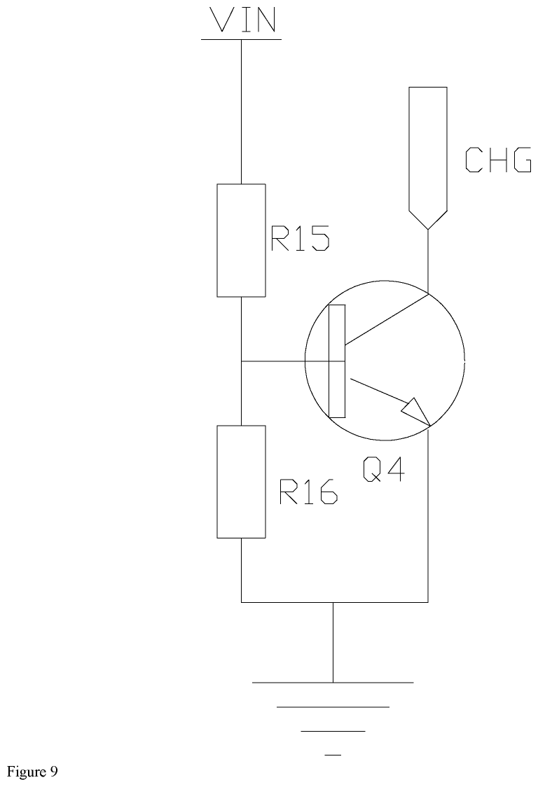

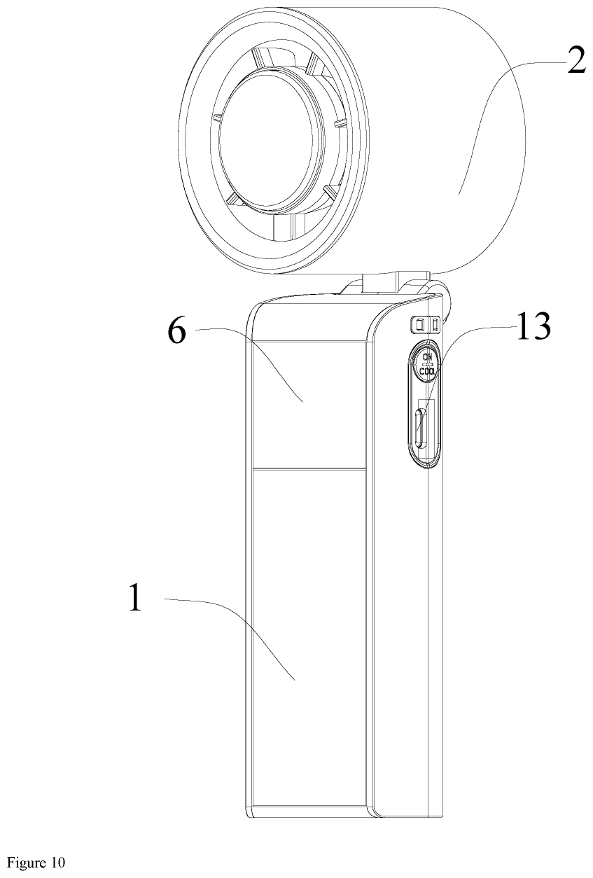

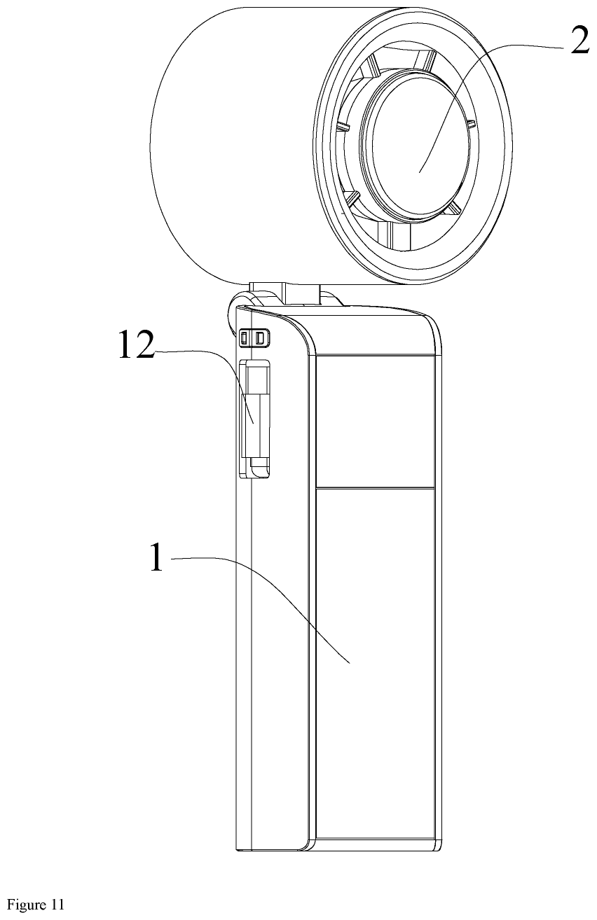

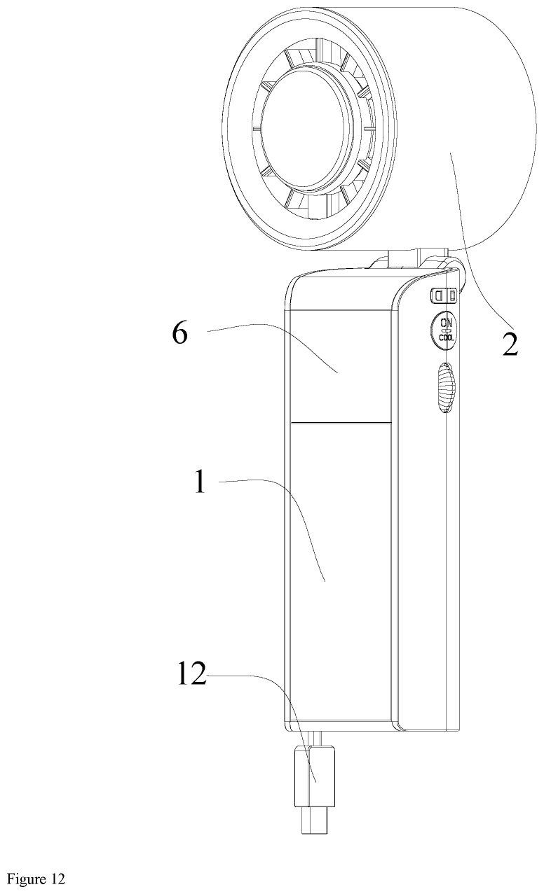

Referring to FIGS. 1 to 11, a handheld fan includes:
a holding part 1 provided with an accommodating space inside and equipped with a discharge port 12 and a charging port 13, the discharge port 12 being configured for electrical connection to an external electronic device, and the charging port 13 being configured for electrical connection to an external power source;
a fan head 2 connected to the holding part 1 and provided with a motor 21 and fan blades 22 connected to the motor 21;
a control device 3 located in the accommodating space and including:
a power module 31 electrically connected to the motor 21, a processor 32, a charging circuit 37, and a current output circuit 38;
the processor 32 electrically connected to the motor 21, the charging circuit 37 and the current output circuit 38, and configured for controlling output power of the motor 21, generating a first control signal to the charging circuit 37 based on a first state signal from the charging circuit 37, and generating a second control signal to the current output circuit 38 based on a second state signal from the current output circuit 38;
the charging circuit 37 electrically connected to the charging port 13 and configured for detecting an input state of external current at the charging port 13 and a state of the power module 31, generating the first state signal accordingly, and regulating a charging state of the power module 31 according to the first control signal from the processor; and
the current output circuit 38 electrically connected to the processor 32 and the discharge port 12, and configured for detecting whether an external electronic device is connected to the discharge port 12, generating a second state signal accordingly, and regulating current to the external electronic device according to the second control signal.

With the above structure, a handheld fan with controllable charging and discharging, external power supply capability, and adjustable wind speed is provided.

For example, when the charging port 13 is connected to an external power source, the charging circuit 37 detects current input and meanwhile detects a power level of the power module 31 by measuring a voltage of the power module 31. If the power of the power module 31 is insufficient, the charging circuit 37 generates a first state signal of “external power connection confirmed and insufficient power detected”. The processor 32 receives the first state signal and generates a first control signal of “charging with a current of X amperes”. The charging circuit 37 receives the first control signal and charges the power module 31. When the power of the power module 31 reaches 100%, the charging circuit 37 generates a first state signal of “full power”. The processor 32 receives the first state signal and generates a first control signal of “stop charging”, and the charging circuit 37 stops charging the power module 31. When an external electronic device, such as a mobile phone, is connected to the discharge port 12, the current output circuit 38 detects a connection signal and power supply demand of the mobile phone, and generates a second state signal of “device connection confirmed and X amperes of current required”. The processor 32 receives the second state signal and generates a second control signal of “outputting X amperes of current”. The current output circuit 38 receives the second control signal and electrically connects the power module 31 to the discharge port 12, enabling the power module 31 to supply power to the mobile phone through the discharge port 12. When the mobile phone is disconnected, the current output circuit 38 detects the disconnection of the mobile phone and generates a second state signal of “no device connected”. The processor 32 receives the second state signal and generates a second control signal of “stop discharging”, and the current output circuit 38 disconnects the discharge port 12 from the power module 31 accordingly. Furthermore, the processor 32 can generate different power control signals according to different commands received from the outside, to effectively adjust the power of the motor 21. For example, when a “low wind speed” command is received, the processor 32 outputs a “low-power” control signal, and a rotation speed of the motor 21 is regulated to 1500 r/min; when a “high wind speed” command is received, the processor 32 outputs a “high-power” control signal to regulate the rotation speed of the motor 21 to 3000 r/min or the like.

In an embodiment, the power module 31 includes a battery 311, and the battery 311 is a secondary battery.

In this embodiment, the charging circuit 37 includes a second filter capacitor C2, a third filter capacitor C6, a fourth current-limiting resistor R1, and a power management Integrated Circuit (“IC”) chip U2. The charging port 13 is a USB interface USB1, which is connected to the power management IC chip U2. A VIN node of the charging circuit 37 is connected both to a VBUS pin of the USB interface USB1 and an IN pin of the power management IC chip U2. One terminal of the fourth current-limiting resistor R1 is connected to the VIN node of the charging circuit 37, and the other terminal of the fourth current-limiting resistor R1 is connected to a GND pin of the power management IC chip U2. The second filter capacitor C2 and the third filter capacitor C6 are connected in parallel to the power management IC chip U2.

With the above structure, the charging circuit 37 constructs a complete, safe, and stable charging management system, which can efficiently control the charging of the battery 311 by an external power source, and ensure the reliability of the circuit through its built-in hardware protection and filtering function.

The VBUS pin of the USB interface USB1 serving as the charging port 13 is directly connected to the IN pin of the power management IC chip U2 and the VIN node, an input path from the external power source (such as a USB charger or computer interface) to a core of the charging management is established. This design is fully compatible with the general USB charging specification, allowing the handheld fan to be conveniently charged through a common USB cable without a dedicated charger, which greatly improves the versatility and usability of the handheld fan.

The fourth current-limiting resistor R1 is connected in series between the VIN node and the GND pin of the power management IC chip U2. When voltage fluctuations (such as instantaneous high voltage) occur in the external power source or a non-standard power source is connected, the fourth current-limiting resistor R1 limits peak current flowing through the power management IC chip U2 through its impedance, and prevents sensitive components of the power management IC chip U2 from being damaged by excessive current. Furthermore, the fourth current-limiting resistor R1 slows down the rate of current change and reduces damage to the power management IC chip U2 caused by instantaneous current surges, and plays a key buffering and protection role—particularly during the initial stage of charging or when the power source is unstable. Furthermore, the second filter capacitor C2 and the third filter capacitor C6 are connected in parallel to the power management IC chip U2. The second filter capacitor C2 and the third filter capacitor C6 absorb high-frequency noise and voltage ripples from the external power source, reduce electromagnetic interference generated during the circuit's operation, and thus make the voltage input to the power management IC chip U2 smoother and more stable.

In this embodiment, the charging circuit 37 further includes a second inductor L1 and a fourth filter capacitor C5. One terminal of the second inductor L1 is connected to a SW pin of the power management IC chip U2, and the other terminal of the second inductor L1 is connected to an output terminal of the power module 31. One terminal of the fourth filter capacitor C5 is connected to the output terminal of the power module 31, and the other terminal of the fourth filter capacitor C5 is connected to the GND pin of the power management IC chip U2.

With the above structure, when the power management IC chip U2 supplies power to the second inductor L1 through the SW pin, the second inductor L1 stores magnetic field energy due to the change in current. When the power management IC chip U2 stops supplying power to the second inductor L1 through the SW pin, the second inductor L1 generates a back electromotive force to maintain current stability and releases the stored energy to the battery 311. The conversion from the input voltage to the charging voltage of the battery 311 is accordingly achieved.

By connecting the fourth filter capacitor C5 in parallel between a positive electrode of the battery 311 and the GND pin of the power management IC chip U2, the voltage ripple during the charging process is removed, and the voltage input to the battery 311 is stabilized.

In this embodiment, the current output circuit 38 includes a fifth filter capacitor C3, a sixth filter capacitor C4, and a fifth current-limiting resistor R2. The discharge port 12 is a USB interface USB2. One terminal of each of the fifth filter capacitor C3, the sixth filter capacitor C4 and the fifth current-limiting resistor R2 is connected to an OUT pin of the power management IC chip U2, the other terminal of the fifth current-limiting resistor R2 is connected to a D+ pin 2A of the USB interface USB2, and the other terminal of each of the fifth filter capacitor C3 and the sixth filter capacitor C4 is connected to the GND pin of the power management IC chip U2. A VBUS pin 3A of the USB interface USB2 is connected to the OUT pin of the power management IC chip U2, and the ground pin 1A of the USB interface USB2 is connected to the GND pin of the power management IC chip U2.

With the above structure, the USB interface USB2 serves as the discharge port 12. The VBUS pin 3A of the USB interface USB2 is connected to the OUT pin (namely a voltage outputting terminal) of the power management IC chip U2, and the ground pin 1A of the USB interface USB2 is connected to the GND pin of the power management IC chip U2. A power supply interface that conforms to the USB standard is realized. This design allows the handheld fan not only to fulfill its basic duty but also to be used as a temporary mobile power source to supply power to other USB devices, for example, the handheld can be used as an emergency power supply of mobile phones and Bluetooth headsets. The application scenarios of the handheld fan are thus significantly expanded. Furthermore, by connecting the D+ pin 2A of the USB interface USB2 to the fifth current-limiting resistor R2, effective current division is achieved and damage due to excessive current is prevented.

By connecting the fifth filter capacitor C3 and the sixth filter capacitor C4 in parallel between the OUT pin and the GND pin of the power management IC chip U2, high-frequency ripples and noise (such as interference generated by switching circuits of the power management IC chip U2) in the output voltage of the power management IC chip U2 and instantaneous voltage fluctuations generated at the moment of connecting an external device to the handheld fan can be effectively absorbed. Furthermore, due to the fifth current-limiting resistor R2 connected between the OUT pin and the GND pin, the maximum output current is effectively limited and circuit damage caused by abnormalities of external devices is avoided.

In this embodiment, the control device 3 further includes a charging detection circuit 39. The charging detection circuit 39 is connected to the power module 31 and the processor 32, and is configured for detecting a charging state and feeding back a signal corresponding to the charging state to the processor 32.

With the above structure, direct and accurate detection of the charging state is realized, and real-time and reliable feedback of the signal corresponding to the charging state is ensured.

For example, the signal corresponding to the charging state, which is fed back by the charging detection circuit 39, is the core basis for the processor 32 to perform charging management. Based on this signal, the processor 32 determines whether to start or stop charging, whether to trigger overcurrent protection, overvoltage protection, or over-temperature protection, and whether to switch to a trickle charging mode, etc. Through this closed-loop control of “detection-feedback-decision”, issues such as invalid charging, overcharging can be effectively avoided. This not only ensures the electricity safety of the power module 31 and external devices but also reduces unnecessary energy consumption and improves the energy efficiency ratio of the entire control device 3.

In this embodiment, the charging detection circuit 39 includes a bipolar transistor Q4, a sixth current-limiting resistor R15, and a pull-down resistor R16. One terminal of the sixth current-limiting resistor R15 is connected to the VIN node of the charging circuit 37, and the other terminal is connected to a base of the bipolar transistor Q4. A collector of the bipolar transistor Q4 is connected to a CHG pin of the processor 32, and an emitter of the bipolar transistor Q4 is grounded. One terminal of the pull-down resistor R16 is connected to the base of the bipolar transistor Q4, and the other terminal of the pull-down resistor R16 is grounded.

With the above structure, one terminal of the pull-down resistor R16 is connected to the base of the bipolar transistor Q4 and the other terminal of the pull-down resistor R16 is grounded. When there is no voltage input at the VIN node of the charging circuit 37, the base of the bipolar transistor Q4 can be reliably pulled to the ground potential. This effectively prevents the conduction of the bipolar transistor Q4 caused by floating voltage at the base due to electromagnetic interference, static electricity, or line parasitic parameters, and ensures an accurate determination of the state that “the CHG pin of the processor 32 inputs a high level when there is no charging input.” On the other hand, the sixth current-limiting resistor R15 is connected in series between the VIN node and the base of the bipolar transistor Q4, the current flowing into the base of the bipolar transistor Q4 is thus limited, thereby preventing the damage to the emitter junction of the bipolar transistor Q4 caused by excessive current when the voltage at the VIN node fluctuates or experiences an instantaneously overvoltage. Thus, the long-term stable operation of the bipolar transistor Q4 is ensured, and the reliability of the entire circuit for detecting the charging state is improved. Based on the switching characteristics, the bipolar transistor Q4 can be quickly switched between on and off states with the change of the voltage at the VIN node. When the VIN node is input a voltage, the bipolar transistor Q4 can be quickly turned on and pulls the CHG pin of the processor 32 to a low level. When the voltage input to the VIN node is removed, the bipolar transistor Q4 can be quickly turned off under the action of the pull-down resistor R16, and the CHG pin returns to a high level accordingly. This fast response characteristic ensures that the processor 32 can obtain the input state of the external current to the charging circuit 37 in real time, provides timely and accurate signals as the basis for subsequent charging management logic (such as charging start/stop control, charging state indication, overcharging protection, etc.), and improves the overall charging control efficiency of the system.

In this embodiment, the control device 3 further includes a motor control circuit 33 electrically connected to the power module 31, the processor 32 and the motor 21. The processor 32 transmits a third control signal to the motor control circuit 33, and the motor control circuit 33 regulates the output power of the motor 21 according to the third control signal.

With the above structure, precise regulation of the output power of the motor 21 can be realized. In detail, under the control of the processor 32, the motor control circuit 33 can flexibly adjust a voltage applied to the motor 21 according to actual needs. When more output power of the motor 21 is needed, the boost circuit 331 can increase the voltage applied to the motor 21 to enhance the driving force of the motor 21. When only low-power operation is needed, the voltage applied to the motor 21 can be reduced to reduce energy consumption. This not only enables the motor 21 to adapt to diversified working scenarios, improves the adaptability and flexibility of the handheld fan, but also optimizes the energy utilization efficiency while ensuring the operation performance, and extends the battery life of the power module 31. Furthermore, through the digital control of the processor 32, the power regulation is more precise and the response is faster, which improves the intelligence level and operation stability of the control device 3.

The third control signal is an adjustment signal input from the outside, such as a signal input by the user through a switch, a regulator or the like, to adjust the output power of the motor 21.

In this embodiment, the motor control circuit 33 includes a boost circuit 331. The boost circuit 331 includes a first inductor L2, a first switch Q1, a rectifier D1, and at least one output energy storage capacitor. The first terminal of the first inductor L2 is connected to an output terminal of the power module 31, and the second terminal of the first inductor L2 is connected to a drain of the first switch Q1 and an anode of the rectifier D1. A source of the first switch Q1 is grounded, and a gate of the first switch Q1 is connected to a PWM pin of the processor 32. A cathode of the rectifier D1, which serves as an output terminal of the boost circuit 331, is connected to a first terminal of the at least one output energy storage capacitor, and a second terminal of the at least one output energy storage capacitor is grounded.

With the above structure, an input voltage of the power module 31 can be stably boosted and converted into the voltage required by the motor 21. For example, when the processor 32 outputs a control signal through the PWM pin to control the first switch Q1 to be turned on, output current of the power module 31 flows through the first inductor L2, and the first inductor L2 stores magnetic field energy due to any change of the current. The rectifier D1 is reverse-biased and cut off because its anode voltage is lower than its cathode voltage, preventing current from flowing to the output terminal of the boost circuit 331. When the processor 32 outputs a control signal through the PWM pin to control the first switch Q1 to be turned off, the first inductor L2 generates a back electromotive force to maintain the current stability, and a voltage generated by the first inductor L2 is superimposed with the power supply voltage. At this time, the rectifier D1 is forward-biased and turned on, and the energy stored in the first inductor L2 is transmitted to the output energy storage capacitors through the rectifier D1. The superimposed voltage is higher than the output voltage of the power module 31, and thus the boosting effect is realized.

In detail, the at least one output energy storage capacitor includes a first output energy storage capacitor C7 and a second output energy storage capacitor C8, and the first output energy storage capacitor C7 is connected in parallel to the second output energy storage capacitor C8.

With the arrangement of the first output energy storage capacitor C7 and the second output energy storage capacitor C8, the output voltage can be smoothed, the voltage fluctuation caused by the on-off of the first switch Q1 during the boosting process can be absorbed, and the operation stability of the motor 21 can be prevented from being affected by voltage pulsation. In addition, the instantaneous current can be added. When the load of the motor 21 changes suddenly (such as during starting or accelerating process), the first output energy storage capacitor C7 and the second output energy storage capacitor C8 can quickly release energy to meet the demand of the motor 21 for instantaneous large current and prevent the output voltage from dropping suddenly.

In this embodiment, the motor control circuit 33 further includes a motor output control circuit 332. The motor output control circuit 332 includes a first current-limiting resistor R7, a second current-limiting resistor R10, a second switch Q2, a first filter capacitor C10, a load resistor R11, and a motor output terminal OUT1. One terminal of the first current-limiting resistor R7 is connected to the output terminal of the boost circuit 331, and the other terminal of the first current-limiting resistor R7 is connected to a gate of the second switch Q2. A first terminal of the load resistor R11 is connected to a source of the second switch Q2, and a second terminal of the load resistor R11 is grounded. A first terminal of the second current-limiting resistor R10 is connected to a gate of the second switch Q2, and a second terminal of the second current-limiting resistor R10 is connected to a MG-ON pin of the processor 32. A first terminal of the first filter capacitor C10 is connected to an OUT_V pin of the processor 32(U3). The OUT_V pin is a voltage output terminal of the processor 32. A second terminal of the first filter capacitor C10 is grounded. A power output pin of the motor output terminal OUT1 is connected to the first current-limiting resistor R7 and the drain of the second switch Q2, and a ground pin of the motor output terminal OUT1 is grounded.

With the above structure, precise control of the power supply to the motor 21 can be realized.

For example, when the MG-ON pin of the processor 32 outputs a high-level signal, the high-level signal is transmitted to the gate of the second switch Q2 through the second current-limiting resistor R10, to turn on the second switch Q2. Then the high voltage output by the boost circuit 331 is applied to the power output pin of the motor output terminal OUT1 through the first current-limiting resistor R7, and the motor 21 is powered on and works. When the MG-ON pin of the processor 32 outputs a low-level signal, the gate of the second switch Q2 is turned off, the motor output terminal OUT1 is disconnected from the boost circuit 331, and the motor 21 stops working.

The first current-limiting resistor R7 is connected in series between the output terminal of the boost circuit 331 and the second switch Q2, which can limit the maximum current flowing through the motor 21. When the motor 21 is short-circuited or overloaded, the first current-limiting resistor R7 can suppress excessive current and avoid damage to the boost circuit 331, the switches, or the motor 21 itself due to overcurrent.

The load resistor R11 is connected between the source of the second switch Q2 and the ground to provide a current loop when the second switch Q2 is turned on.

The first filter capacitor C10 is connected between the OUT_V pin of the processor 32 and the ground to remove voltage ripples and stabilize output voltage of the processor 32. When the control signal output by the processor 32 fluctuates, the first filter capacitor C10 can smooth the voltage through charging and discharging, ensure the stability of the gate voltage of the second switch Q2, avoid mis-conduction or mis-cutoff of the second switch Q2 caused by signal interference, and reliably control the motor 21.

The second current-limiting resistor R10 is connected in series between the MG-ON pin of the processor 32 and the gate of the second switch Q2, which limits the gate drive current, protects the output of the MG-ON pin of the processor 32, and stabilizes the control signal applied to the second switch Q2.

In this embodiment, the fan head 2 further includes a Thermoelectric Cooling (TEC) module 4. The control device 3 includes a TEC control circuit 34 electrically connected to the TEC module 4, the power module 31, and the processor 32. The processor 32 transmits a fourth control signal to the TEC control circuit 34 to regulate current transmitted to the TEC module 4.

With the above structure, the TEC module 4 can realize precise temperature adjustment function under the regulation of the processor 32, and add an active cooling function to the fan head 2. For example, the processor 32 can adjust the current to the TEC module 4 according to an ambient temperature or a mode set by the user, and the TEC control circuit 34 can linearly or stepwise regulate the output current according to the fourth control signal. When an “effective duty cycle” of the fourth control signal increases, the average current output by the TEC control circuit 34 increases, and a cooling power of the TEC module 4 increases. When the “effective duty cycle” of the fourth control signal decreases, the average current output by the TEC control circuit 34 decreases, and the cooling power of the TEC module 4 decreases. This refined adjustment allows the processor 32 to adjust the cooling intensity in real time according to the ambient temperature, user needs, etc., realizing continuous control from “slight cooling” to “strong cooling” and avoiding insufficient cooling or excessive cooling.

The fourth control signal is an adjustment signal input from the outside, such as a signal input by the user through a switch, regulator, or the like, to adjust the TEC module 4 accordingly.

In this embodiment, the TEC control circuit 34 includes a first jumper JMP1 and a fourth switch Q5. A first pin of the first jumper JMP1 is connected to the output terminal of the power module 31, and a second pin of the first jumper JMP1 is connected to a positive electrode of the TEC module 4. A negative electrode of the TEC module 4 is connected to a drain of the fourth switch Q5. A gate of the fourth switch Q5 is connected to a TEC pin of the processor 32, and a source of the fourth switch Q5 is grounded.

With the above structure, when the gate of the fourth switch Q5 receives a signal from the TEC pin of the processor 32, the fourth switch Q5 is turned on. The output current of the power module 31 travels through the first jumper JMP1, the TEC module 4, and the fourth switch Q5 to form a current loop, thereby supplying power to the TEC module 4 and initiating the cooling process. When the gate of the fourth switch Q5 does not receive the signal from the TEC pin of the processor 32, the fourth switch Q5 is turned off, the current loop is interrupted, and the TEC module 4 is powered off and stops cooling.

In this embodiment, the handheld fan further includes an illuminating element 5. The control device 3 includes an illumination driving circuit 35 electrically connected to the illuminating element 5, the power module 31, and the processor 32. The processor 32 transmits a fifth control signal to the illumination driving circuit 35 to regulate current transmitted to the illuminating element 5.

With the above structure, the handheld fan of the present application is equipped with an illumination function, and realizes brightness control and energy efficiency optimization under the regulation of the processor 32, which significantly improves the practicality and adaptability of the handheld fan.

For example, when the user requires emergency illumination, the illumination brightness of the illuminating element 5 can be adjusted based on the light intensity of the usage scenario, so as to effectively balance energy consumption and brightness.

In this embodiment, the illuminating element 5 is a white light-emitting diode (LED). The illumination driving circuit 35 includes a third switch Q3 and a third current-limiting resistor R6. One terminal of the third current-limiting resistor R6 is connected to the output terminal of the power module 31, and the other terminal of the third current-limiting resistor R6 is connected to an anode of the white LED. A drain of the third switch Q3 is connected to a cathode of the white LED, a gate of the third switch Q3 is connected to an LED-W pin of the processor 32, and a source of the third switch Q3 is grounded.

With the above structure, when the LED-W pin of the processor 32 outputs a high-level signal to the gate of the third switch Q3, the third switch Q3 is turned on. The output current of the power module 31 travels through the third current-limiting resistor R6, the white LED, and the third switch Q3 to form a closed current loop, and the white LED emits light due to forward conduction. When the LED-W pin of the processor 32 outputs a low-level signal to the gate of the third switch Q3, the gate of the third switch is turned off, and the white LED goes out. In addition, the brightness of the white LED can be adjusted by adjusting a duty cycle.

In this embodiment, the handheld fan further includes a display assembly 6. The display assembly 6 includes a plurality of display elements 36 electrically connected to the processor 32 and the power module 31. The processor 32 controls whether to supply current to each display element 36.

With the above structure, the display assembly 6 can realize visual display of statuses of the handheld fan under the control of the processor 32. For example, the plurality of display elements 36 can, under the control of the processor 32, intuitively display the statuses of the handheld fan, such as remaining power, fan gear, abnormal status, mode selection, etc., through on/off or brightness change of each display element 36, as well as combinations of more than one display elements 36. The status change of the display elements 36 can be used as real-time feedback of user operations. For example, when the user adjusts the wind speed, the display element 36 corresponding to the gear is lit synchronously to confirm that the operation takes effect. When the illumination function is activated, the display element 36 corresponding to the illumination mode responds immediately. This immediacy of “operation-feedback” makes the user have a stronger sense of control over the handheld fan and improves the smoothness of the user experience.

In this embodiment, each display element 36 includes a plurality of light-emitting diodes (LEDs). Anodes of the LEDs are connected to the processor 32, and cathodes of the LEDs are connected to a common cathode terminal.

With the above structure, anodes of the LEDs are connected to pins of the processor 32 one to one, so that the processor 32 can accurately control the on/off of each LED by individually controlling a potential level (high/low) of a corresponding pin. Through the combinations of on-off statuses of the independently controlled LEDs, the status information of the handheld fan, such as remaining power, fan gear, abnormal state, mode selection, etc., can be effectively output to the user. Furthermore, the cathodes of the LEDs share a common terminal, thereby significantly reducing the number of circuit wirings and interfaces required.

In this embodiment, the fan head 2 is rotatably connected to the holding part 1.

With the above structure, the fan head 2 can rotate flexibly relative to the holding part 1 (e.g., pitching up and down, swinging left and right), allowing the user to accurately adjust an air-blowing angle according to the usage scenario. When held by hand, the fan head 2 can be turned to face different parts such as the face, neck, or abdomen, delivering cool air in a specific direction and thus avoiding the loss of airflow caused by wind blowing to irrelevant areas.

In this embodiment, the holding part 1 is provided with a first rotating shaft 14 and a second rotating shaft 15. A first end of the first rotating shaft 14 is rotatably connected to the holding part 1, a first end of the second rotating shaft 15 is rotatably connected to a second end of the first rotating shaft 14, and a second end of the second rotating shaft 15 is connected to the fan head 2.

With the above structure, the fan head 2 has significantly more degrees of adjustment freedom than a single rotating shaft, which greatly enhances the usability flexibility and scenario adaptability of the handheld fan.

For example, through the cooperation of the first rotating shaft 14 and the second rotating shaft 15, the fan head 2 can blow directly upward, obliquely upward, to the side, etc.

In addition, when the handheld fan is placed on a desktop, the fan head 2 can be raised, lowered, or turned to a side through the first rotating shaft 14 and the second rotating shaft 15 to expand the air supply range or focus on a specific direction, and the air supply angle can be adjusted without moving the holding part 1.

In this embodiment, the discharge port 12 is a built-in retractable USB interface.

With the above structure, the built-in retractable structure allows the USB interface to be completely stored inside the handheld fan when not in use. When in use, the USB interface can be pulled out of the handheld fan for direct connection to an external device, which saves the usage space and effectively reduces the space occupied by the USB interface.

### Second Embodiment

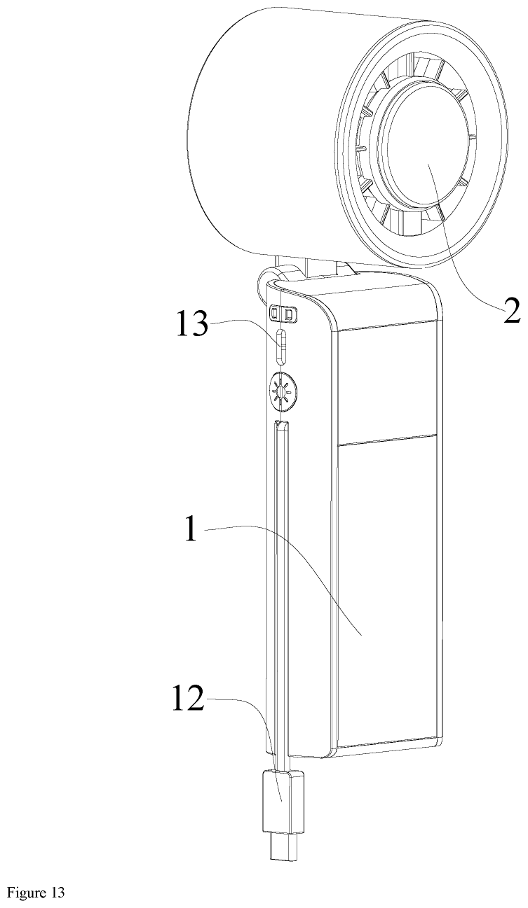

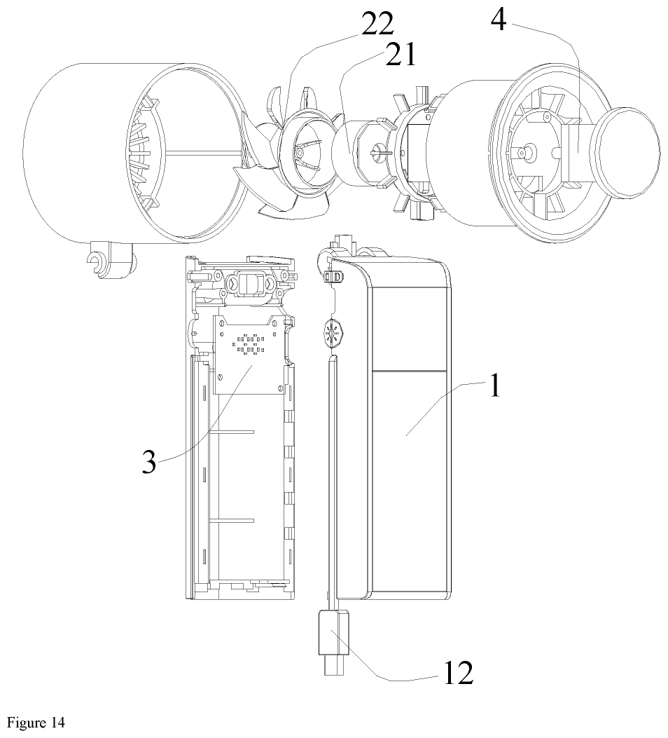

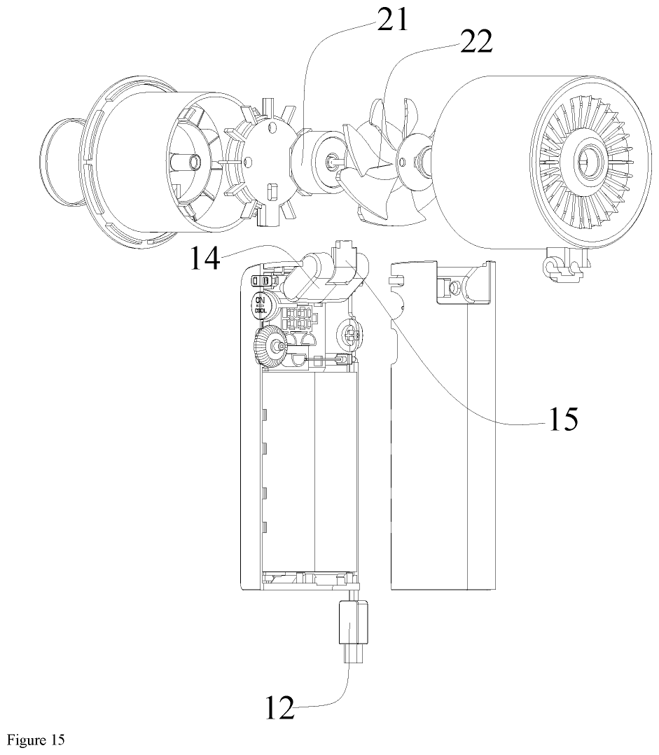

Referring to FIGS. 12 to 15, the basic structure, principle, and technical effects of a handheld fan provided in this embodiment are the same as those of the first embodiment. For the sake of brief description, the parts not mentioned in this embodiment can refer to the corresponding contents in the first embodiment.

In this embodiment, the discharge port 12 is an external USB interface.

With the above structure, the external arrangement allows the USB interface to be directly exposed outside the handheld fan, and an external device to be charged can be directly plugged in without additional operations (such as stretching and unlocking), which enhances user convenience and improves the user experience.

The above are one or more embodiments provided in conjunction with specific contents, and the embodiments of the present application shall not be deemed limited to these descriptions. Any technical deductions or substitutions made on the premise of the concept of the present application that are similar or identical to the method and structure of the present application, shall be deemed to fall within the claimed scope of the present application.

1. A handheld fan, comprising:
a holding part provided with an accommodating space inside and equipped with a discharge port and a charging port, the discharge port being configured for electrical connection to an external electronic device, and the charging port being configured for electrical connection to an external power source;
a fan head connected to the holding part and provided with a motor and fan blades connected to the motor; and
a control device located in the accommodating space and comprising:
a power module electrically connected to the motor, a processor, a charging circuit, and a current output circuit;
the processor electrically connected to the motor, the charging circuit and the current output circuit, and configured for controlling output power of the motor, generating a first control signal to the charging circuit based on a first state signal from the charging circuit, and generating a second control signal to the current output circuit based on a second state signal from the current output circuit;
the charging circuit electrically connected to the charging port and configured for detecting an input state of external current at the charging port and a state of the power module, generating the first state signal accordingly, and regulating a charging state of the power module according to the first control signal from the processor; and
the current output circuit electrically connected to the processor and the discharge port, and configured for detecting whether an external electronic device is connected to the discharge port, generating a second state signal accordingly, and regulating current to the external electronic device according to the second control signal.

2. The handheld fan according to claim 1, wherein the charging port is a USB interface, the charging circuit comprises:
a VIN node connected to a VBUS pin of the USB interface;
a second filter capacitor;
a third filter capacitor;
a fourth current-limiting resistor having one terminal connected to a VIN node of the charging circuit, and another terminal connected to a GND pin of a power management IC chip; and
the power management IC chip connected to the USB interface and having an IN pin connected to the VIN node,
wherein the second filter capacitor and the third filter capacitor are connected in parallel to the power management IC chip.

3. The handheld fan according to claim 2, the charging circuit further comprises:
a second inductor having one terminal connected to a SW pin of the power management IC chip and another terminal connected to an output terminal of the power module; and
a fourth filter capacitor having one terminal connected to the output terminal of the power module and another terminal connected to the GND pin of the power management IC chip.

4. The handheld fan according to claim 3, wherein the discharge port is another USB interface having a VBUS pin connected to an OUT pin of the power management IC chip and a ground pin connected to the GND pin of the power management IC chip, and the current output circuit comprises:
a fifth filter capacitor having one terminal connected to an OUT pin of the power management IC chip and another terminal connected to the GND pin of the power management IC chip;
a sixth filter capacitor having one terminal connected to the OUT pin of the power management IC chip and another terminal connected to the GND pin of the power management IC chip; and
a fifth current-limiting resistor having one terminal connected to the OUT pin of the power management IC chip and another terminal connected to a D+ pin of the another USB interface.

5. The handheld fan according to claim 2, wherein the control device further comprises a charging detection circuit connected to the power module and the processor, and is further configured for detecting a charging state and feeding back a signal corresponding to the charging state to the processor.

6. The handheld fan according to claim 5, wherein the charging detection circuit comprises:
a bipolar transistor comprising a base, a collector connected to a CHG pin of the processor, and an emitter grounded;
a sixth current-limiting resistor having one terminal connected to the VIN node of the charging circuit and another terminal connected to the base of the bipolar transistor; and
a pull-down resistor having one terminal connected to the base of the bipolar transistor and another terminal grounded.

7. The handheld fan according to claim 1, wherein the control device further comprises a motor control circuit electrically connected to the power module, the processor, and the motor, the processor is further configured for sending a third control signal to the motor control circuit, and the motor control circuit is configured for regulating output power of the motor according to the third control signal.

8. The handheld fan according to claim 7, wherein the motor control circuit comprises a boost circuit, and the boost circuit comprises:
a first inductor having a first terminal connected to the output terminal of the power module, and a second terminal;
a first switch comprising a gate connected to a PWM pin of the processor, a source grounded, and a drain connected to the second terminal of the first inductor;
a rectifier having an anode connected to the second terminal of the first inductor, and a cathode forming an output terminal of the boost circuit; and
at least one output energy storage capacitor having a first terminal connected to the cathode of the rectifier, and a second terminal grounded.

9. The handheld fan according to claim 8, wherein the motor control circuit further comprises a motor output control circuit, and the motor output control circuit comprises:
a second switch comprising a gate connected to a MG-ON pin of the processor, a source, a drain connected to the output terminal of the boost circuit;
a load resistor having a first terminal connected to the source of the second switch, and a second terminal grounded; and
a motor output terminal comprising a power output pin connected to the motor and the drain of the second switch, and a ground pin grounded.

10. The handheld fan according to claim 9, wherein the motor output control circuit further comprises a first current-limiting resistor connected between the output terminal of the boost circuit and the gate of the second switch.

11. The handheld fan according to claim 10, wherein the motor output control circuit further comprises a second current-limiting resistor connected between the gate of the second switch and the MG-ON pin of the processor.

12. The handheld fan according to claim 11, wherein the motor output control circuit further comprises a first filter capacitor connected between a voltage output terminal of the processor and ground.

13. The handheld fan according to claim 1, wherein the fan head comprises a TEC module, the control device further comprises a TEC control circuit electrically connected to the TEC module, the power module, and the processor, the processor is further configured for sending a fourth control signal to the TEC control circuit, and the TEC control circuit is configured for regulating the current to the TEC module according to the fourth control signal.

14. The handheld fan according to claim 13, wherein TEC control circuit comprises:
a first jumper comprising a first pin connected to the output terminal of the power module, and a second pin connected to a positive electrode of the TEC module; and
a fourth switch comprising a gate connected to a TEC pin of the processor, a source grounded, and a drain connected to a negative electrode of the TEC module.

15. The handheld fan according to claim 1, wherein the handheld fan further comprises an illuminating element, the control device further comprises an illumination driving circuit electrically connected to the illuminating element, the power module, and the processor, the processor is further configured for sending a fifth control signal to the illumination driving circuit, and the illumination driving circuit is configured for regulating current to the illuminating element according to the fifth control signal.

16. The handheld fan according to claim 15, wherein the illuminating element is a white LED, and the illumination driving circuit comprises:
a third switch comprising a gate connected to an LED-W pin of the processor, a source grounded, and a drain connected to a cathode of the white LED; and
a third current-limiting resistor connected between the output terminal of the power module and an anode of the white LED.

17. The handheld fan according to claim 1, wherein the handheld fan further comprises a display assembly, the display assembly comprises a plurality of display elements electrically connected to the processor and the power module, and the processor is further configured for controlling whether to supply current transmitted to each display element.

18. The handheld fan according to claim 17, wherein the display elements comprise a plurality of LEDs, anodes of the plurality of LEDs are connected to pins of the processor one to one, and cathodes of the plurality of LEDs are connected to a common cathode terminal.

19. The handheld fan according to claim 1, wherein the fan head is rotatably connected to the holding part.

20. The handheld fan according to claim 19, wherein the holding part is provided with a first rotating shaft and a second rotating shaft, a first end of the first rotating shaft is rotatably connected to the holding part, a first end of the second rotating shaft is rotatably connected to a second end of the first rotating shaft, and a second end of the second rotating shaft is connected to the fan head.
